(19) United States
(12) Patent Application Publication
(10) Pub. No.: US 2015/0317635 A1
(43) Pub. Date: Nov. 5, 2015

(54) ELECTRONIC GESTURE-BASED SIGNATURES

(71) Applicant: TollShare, Inc., Danville, CA (US)

(72) Inventors: Murali M. Karamchedu, Portland, OR (US); Ravi Asnani, Los Angeles, CA (US)

(73) Assignee: TollShare, Inc., Danville, CA (US)

(21) Appl. No.: 14/268,887

(22) Filed: May 2, 2014

(51) Int. Cl. G06Q 20/40

(52) U.S. Cl. CPC G06Q 20/4014

(57) ABSTRACT

In various embodiments, facilitation of transactions using electronic gesture-based signatures is described. A party participating in a transaction may provide an electronic signature using a mobile device. The mobile device may be configured to record electronic signature data made through physical manipulation of the mobile device, such as by recording data from one or more instruments of the mobile device. The mobile device may then send the electronic signature data to a gesture-based signature confirmation system (“GSC”), which may confirm an identity of the party and/or confirm an intent of the party to participate in the transaction. The GSC may send an indication to another party to the transaction that the identity has been confirmed, and/or that the first party intends to participate in the transaction, and may generate a record of the signature. Other embodiments are described and claimed.

### TECHNICAL FIELD

The present disclosure relates to the field of data processing, in particular, to apparatuses, methods and storage media associated with electronic gesture-based signatures.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Individual parties engage in multiple commercial and legal transactions every day. Many of these transactions involve the collection of one or more signatures. In various scenarios, signatures may be used to identify a party as well as to confirm a party's intention to participate in the transaction. However, as transactions are increasingly carried out through electronic means, signature requires may become increasingly cumbersome. Electronic documents are not always easily “signed,” especially if a party does not have the ability to create a signature and scan the signature for inclusion in the electronic document. Further, such requirements may reduce the ease and convenience that is, for some, a major benefit of use of electronic documents.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for utilizing electronic gesture-based signatures, in accordance with various embodiments.

FIG. 2 illustrates an example use case of facilitating a purchase transaction using electronic gesture-based signatures, in accordance with various embodiments.

FIG. 3 illustrates an example process for facilitating a purchase transaction using electronic gesture-based signatures, in accordance with various embodiments.

FIG. 4 illustrates an example use case of facilitating a payment using electronic gesture-based signatures, in accordance with various embodiments.

FIG. 5 illustrates an example process for facilitating a payment using electronic gesture-based signatures, in accordance with various embodiments.

FIG. 6 illustrates an example use case of facilitating a notarization of an electronic document, in accordance with various embodiments.

FIG. 7 illustrates an example process for facilitating a notarization of an electronic document, in accordance with various embodiments.

FIG. 8 illustrates an example process for facilitating performance of a transaction, in accordance with various embodiments

FIG. 9 illustrates an example computing environment suitable for practicing various aspects of the present disclosure, in accordance with various embodiments.

FIG. 10 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

In various embodiments, methods, systems, apparatuses, devices, and computer-readable media directed to facilitation of transactions using electronic gesture-based signatures are described. In various embodiments, a party participating in a transaction may provide an electronic signature, such as for an electronic document, using a mobile device. In various embodiments, the mobile device may be configured to record electronic signature data made through physical manipulation of the mobile device. For example, the mobile device may record data from one or more of an accelerometer, compass, gyroscope and/or other instruments to detect movement of the mobile device by the party. The mobile device may then send the electronic signature data to a gesture-based signature confirmation system (“GSC”). The GSC may, in turn, confirm an identity of the party based on the electronic gesture-based signature and/or confirm an intent of the party to participate in the transaction. The GSC may then send an indication to an other party to the transaction that the first party's identity has been confirmed, and/or that the first party intends to participate in the transaction, and may generate a record of the signature. Thus, by use of the GSC, the electronic gesture-based signature may be verified and recorded, facilitating the collection of a signature without requirements of physical pen and paper or complicated hardware. In various embodiments, the GSC may be configured to facilitate purchase transactions, payments, and/or notarization of electronic documents. In various embodiments, multiple signers may provide electronic signatures for a single document and/or transaction.

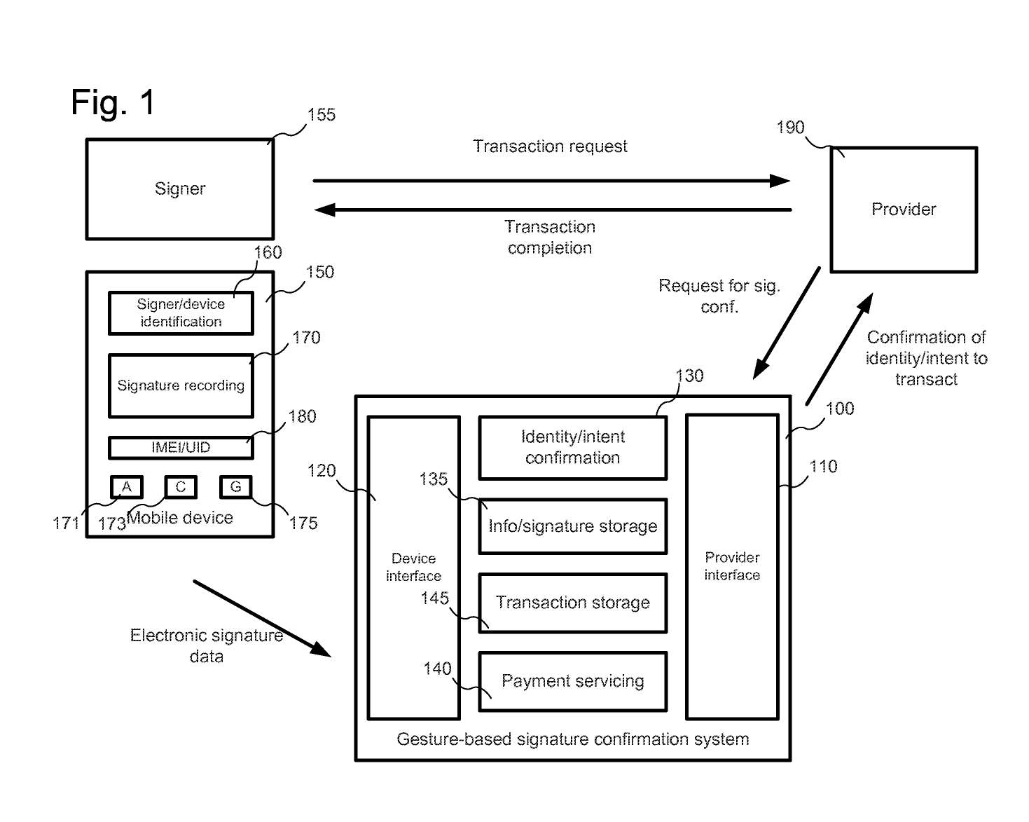

Referring now to FIG. 1, an example arrangement for utilizing electronic gesture-based signatures is shown. In various embodiments, a gesture-based signature confirmation system 100 (“GSC 100”) may be configured to interact with a mobile device 150 and a provider 190 in order to facilitate a transaction between the provider 190 and a signer 155 that has control of the mobile device 150. In various embodiments, the provider 190 may include various providers of goods and/or services, such as, but not limited to, sales of goods and or services, provision of financial and/or payment services, provision of notary services, and/or provision of other services and goods. Particular examples of providers 190 are described below with respect to particular example use cases. In various embodiments, the provider 190 may be a party to a contract, such as a party asking the signer 155 to sign a contract for goods or services provided by the signer 155.

In various embodiments, the mobile device 150 under control of the signer 155 may include various computing devices. In particular example embodiments described herein, the mobile device 150 may include a mobile phone. However, in alternative embodiments, other devices may be utilized. In various embodiments, the mobile device 150 may include a unique identifier 180, such as, for example, an International Mobile Station Equipment Identity number (“IMEI number”).

In various embodiments, the GSC 100 may be configured to communicate with the provider 190 and the mobile device 150 to facilitate transactions. In various embodiments, the GSC 100 may include one or more modules to facilitate transactions. For example, the GSC 100 may include a provider interface module 110, which may be configured to receive and/or send messages and/or data between the GSC 100 and the provider 190. In various embodiments, the provider interface module 110 may be configured to provide human-usable interface, such as, for example, a web interface including graphics and/or text, through which a human associated with the provider may communicate with the GSC 100. In other embodiments, the provider interface 110 may include one or more automated communication protocols, such that automated communications may be performed between the provider 190 (and/or one or more computing devices under control of the provider 190) and the GSC 100. Similarly, the GSC 100 may include a device interface module 120. In various embodiments, the device interface module 120 may be configured to communicate with one or more mobile devices 150. In various embodiments, such communication may be performed via various protocols, including TCP/IP, Ethernet, WiFi, Bluetooth, and/or other protocols.

In various embodiments, the GSC 100 may be configured to receive a request from the provider 190 to confirm an identity of the signer 155 and/or an intent of the signer 155 to participate in the transaction. In various embodiments, the request for identity/intent confirmation may be received from the provider 190 in response to a request from the signer 155 for a transaction. In various embodiments, the request sent by the provider 190 may include identifying information for the signer 155 and/or the mobile device 150. For example, in various embodiments, in various embodiments, the identifying information may include information about the signer 155, such as name information, address information, a photo, and/or other information. In other embodiments, the identifying information may include information relating to the mobile device 150, such as a phone number or IMEI number. The provider 190 may then, in turn provide the identifying information to the GSC 100 when sending a request to confirm the identity/intent of the signer 155. The request received from the provider 190 may also include additional information about the transaction, such as an identification of the transaction, a purchase amount, etc.

In various embodiments, the GSC 100 may also be configured such that the GSC 100 may receive electronic signature data from the mobile device 150. In various embodiments, the GSC 100 may be configured to receive this electronic signature data either before or after receiving a request from the provider 190 to confirm an identity/intent of the signer 155. Thus, the signer 155 may, in various embodiments, provide an electronic gesture-based signature to the GSC 100 in an asynchronous action from the identity/intent confirmation request received from the provider 190.

In various embodiments, the mobile device 150 may be configured to record electronic signature data. In various embodiments, the electronic signature data may describe a signature formed through one or more gestures made by the signer 155 using the mobile device 150. For example, the signer 155 may move the mobile device 150 through the air (free space) in a controlled pattern to provide his or her signature. While, in some embodiments, the electronic gesture-based signature may resemble a paper-based signature that might be otherwise generated by the signer 155, in other embodiments, the signer 155 may generate electronic gesture-based signatures that include other patterns or otherwise do not represent a paper-based signature.

In various embodiments, the mobile device 150 may be configured to include one or more modules that facilitate recording of electronic gesture-based signature data and/or provision of such data to the GSC 100. For example, in various embodiments, the mobile device 150 may include a signature recording module 170. In various embodiments, the signature recording module 170 may be configured to record movement data describing movement of the mobile device as the signer 155 performs one or more gestures with the mobile device 150. In various embodiments, the signature recording module 170 may be configured to communicate with one or more movement detection instruments included in the mobile device 150, such as an accelerometer 171, a compass 173, and/or a gyroscope 175. In various embodiments, the signature recording module 170 may be configured to provide an interface to the signer 155 such that the signer 155 may know when he or she may perform the one or more gestures that form his or her electronic gesture-based signature. Thus, the signature recording module 170 may visually or aurally indicate to the signer 155 when the signer 155 may begin gestures, and/or when the mobile device 150 has completed recording the electronic signature.

In various embodiments, the mobile device 150 may also include a signer/device identification module 160. In various embodiments, the signer/device identification module 160 may be configured to provide identifying information about the signer 155 and/or the mobile device 150 to the GCS 100 so that the electronic gesture-based signature that is recorded may be confirmed against the identifying information by the GSC 100. In various embodiments, the signer/device identification module 160 may provide information about the signer 155, such as name information, location information, address information and/or other identifying information. In various embodiments, the signer/device identification module 160 may additionally provide one or more photos of the signer 155 to the GSC 100. These photos maybe taken either contemporaneously with performance of the electronic gesture-based signature or may include photos that were captured prior to performance of the electronic gesture-based signature. In various embodiments, the signer/device identification module 160 may be configured to provide identifying information specific to the mobile device 150. For example, the signer/device identification module 160 may be configured to provide a unique identifier 180, such as an IMEI number, to the GCS 100. In other embodiments, other unique identifiers, such as, for example, a mobile phone number associated with the mobile device, may be provided to the GCS 100. In yet other embodiments, the signer/device identification module 160 may be configured to provide a location for the mobile device 150, such as a location received from a GPS module of mobile device 150 (not illustrated) or other location-aware module. In various embodiments, the signer/device identification module 160 may be configured to encrypt the unique identifier 180 before sending the confirmation message. In various embodiments, information other than pure signature data, such as identifying information and/or information specific to the mobile device 150, may be included in the electronic gesture-based signature data sent to the GSC 100.

In various embodiments, through sending of identifying information as well as the electronic gesture-based signature data, the modules of the mobile device 150 may provide reassurance that the person in control of the mobile device 150 is the same signer 155 that is requesting to participate in the transaction with the provider 190. This may provide an increased level of security to the signer 155 and/or the provider 190 during their transaction.

In various embodiments, the GSC 100 may be configured with additional modules configured to perform various operations upon receipt of the electronic gesture-based signature from the mobile device 150. For example, in various embodiments, the GSC 100 may include an identity/intent confirmation module 130 (“IC 130”). The IC 130 may be configured to confirm an identity of the signer 155 based, at least in part, on a comparison of received electronic signature data with previously-stored electronic signature data. Thus, in various embodiments, the GSC 100 may be configured to store identifying information and/or electronic signature data in identifying information/signature storage 135. Later, in various embodiments, this identifying information and/or electronic signature data may be compared by the IC 130 to identifying information and/or electronic signature data received from the mobile device.

In various embodiments, the GSC may also include transaction storage 145. In various embodiments, the transaction storage 145 may be configured to store one or more records of transactions for which identities have been confirmed by the GCS 100. Thus, in various embodiments, the GCS 100 may act as a record keeper for previous transactions, for the benefit of the signer 155 and/or the provider 190. In various embodiments, the GSC 100 may also include a payment servicing module 140. The payment servicing module 140 may be configured to interact with a payment entity (not illustrated), such as a bank, credit union, credit card provider, or other entity, to facilitate payments between the signer 155 and the provider 190. Particular examples of transaction completion are described below.

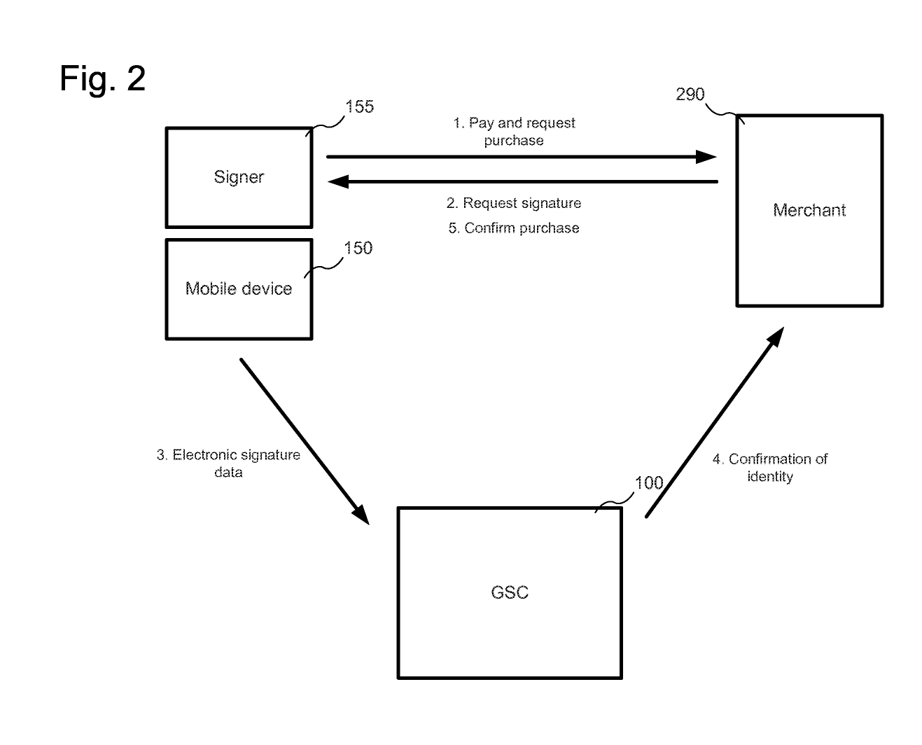

Referring now to FIG. 2, an example use case of facilitating a purchase transaction using electronic gesture-based signatures is illustrated in accordance with various embodiments. In the example, the signer 155 is attempting to purchase an item or service from a merchant 290. The example may begin at action 1, where the signer 155 may offer payment and request purchase of a good or service. It maybe noted that, while in the example use case of FIG. 2, no payment is facilitated by the GSC 100, in other embodiments, payment is facilitated; examples of such payment are discussed below.

Next, at action 2, the merchant 290 may request a signature from the signer 155. Next, at action 3, the mobile device 150 may record and send electronic gesture-based signature data to the GSC 100. Next, the GSC 100 may review the received electronic gesture-based signature data and, at action 4, confirm the identity of the signer 155. At action 5, the merchant may then confirm the purchase with the signer 155.

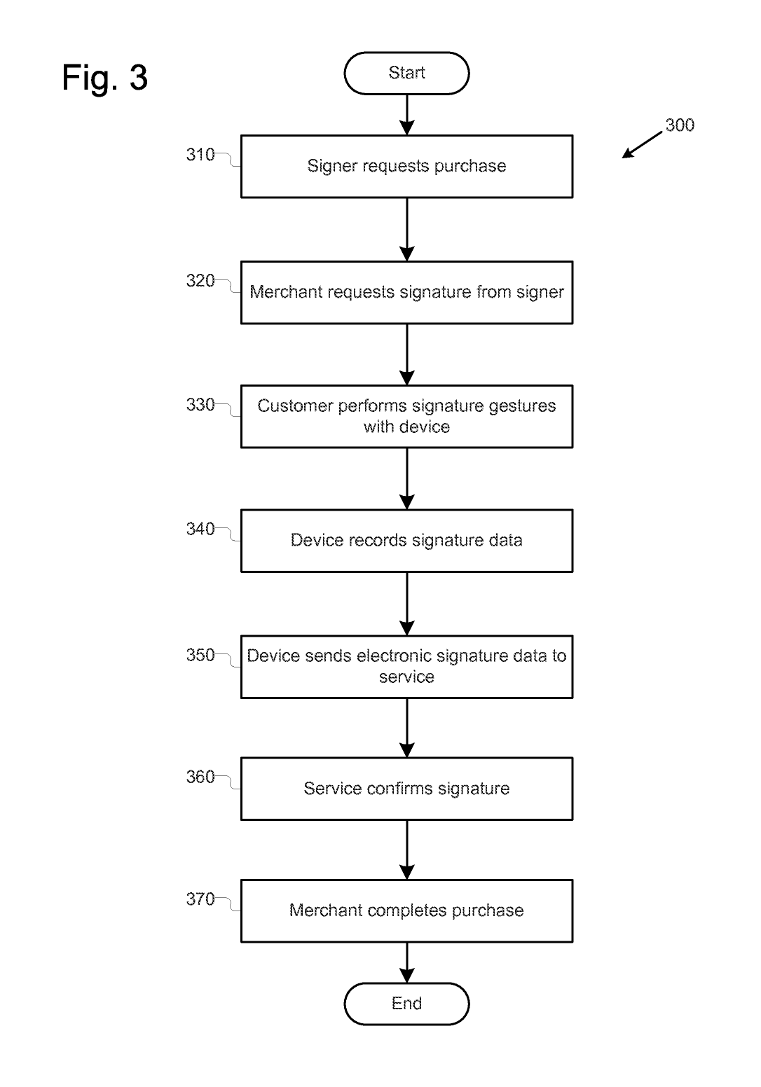

Referring now to FIG. 3, an example process for facilitating a purchase transaction using electronic gesture-based signatures is illustrated in accordance with various embodiments. While FIG. 3 illustrates particular operations in a particular order, in various embodiments, the operations may be combined, split into parts, and/or omitted. The process may begin at operation 310, where the signer 155 may request a purchase of a good or service from the merchant 290. Next, at operation 320, the merchant may request that the signer 155 perform a signature to complete the purchase transaction. At operation 330, the signer 155 may perform a one or more signature gestures with the mobile device 150 in order to generate the gesture-based signature. At operation 340, the mobile device 150 may record electronic gesture-based signature data during performance of the gestures. In various embodiments, the signer 155 may indicate to the mobile device 150, such as through execution of the signature recording module 170, that he or she wishes to record a signature. Then, during operation 340, the recording module 170 may record data taken from one or more of the accelerometer 171, the compass 173, and/or the gyroscope 175 (and/or other instruments of the mobile device 150) to record movements of the phone made while the signer 155 is performing gestures. This movement data may be combined by the signature recording module 170 as electronic gesture-based signature data.

Next, at operation 350, the mobile device 150 may send the recorded electronic gesture-based signature data to the GSC 100. Next, at operation 360, the GSC 100 may confirm the identity of the signer 155 to the merchant 290. In various embodiments, the GSC 100 may be configured, such as through operation at of the IC 130, to confirm the identity of the signer 155. In various embodiments, at operation 360, the IC 130 may retrieve stored electronic gesture-based signature data from the identifying information/signature storage 135 and may compare the electronic gesture-based signature data to the electronic gesture-based signature data received from the mobile device 150. In various embodiments, the electronic gesture-based signature data may be retrieved with reference to identifying information received from the mobile device 150, such as name information, photo information, or IMEI number or other unique identifier. In various embodiments, at operation 360, the IC 130 may determine one or more differences between the received electronic gesture-based signature data and the stored electronic signature data. In various embodiments, if these differences fall below a pre-determined threshold, then the IC 130 may determine that the identity of the signer 155 is confirmed. The IC 130 may then cause a notification to be sent to the merchant 290, such as through the provider interface 110, that indicates that the identity of the signer 155 has been confirmed. Next, at operation 370, the merchant 290 may complete the purchase with the signer 155. The process may then end, or repeated for another purchase.

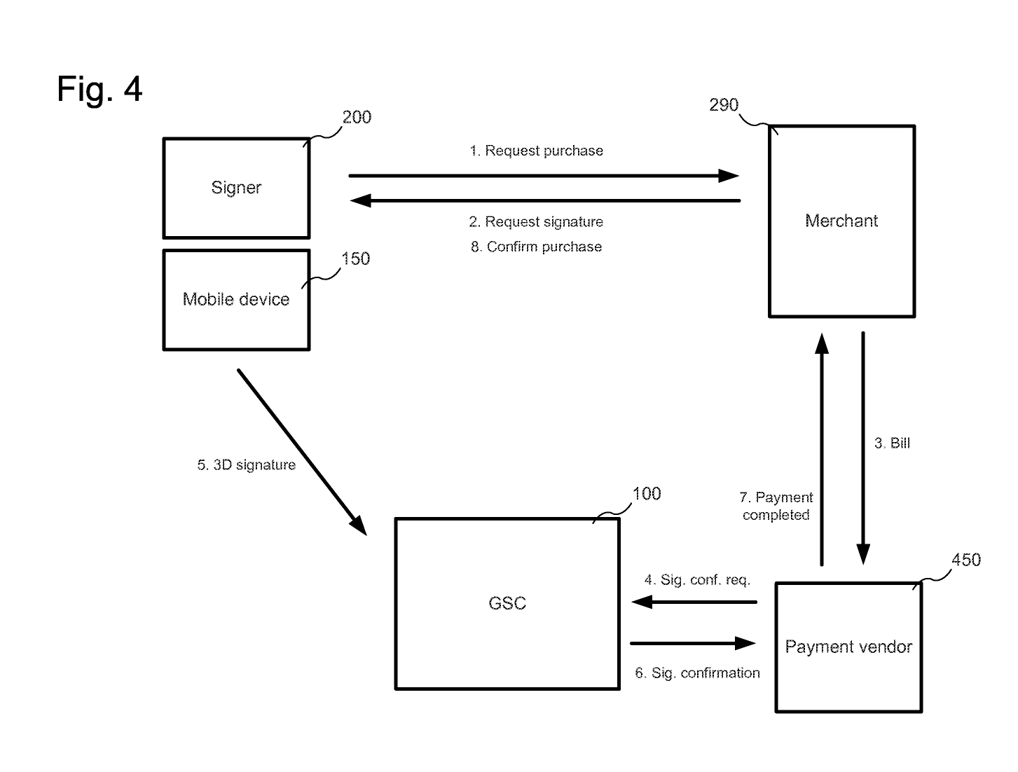

Referring now to FIG. 4, an example use case of facilitating a payment using electronic gesture-based signatures is illustrated in accordance with various embodiments. In the example, the signer 155 is attempting to perform a purchase with a merchant 290 that is facilitated by a payment vendor 450. The example may begin at action 1, where the signer 155 may request purchase of a good or service from the merchant 290. Next, at action 2, the merchant 290 may request a signature from the signer 155. The merchant 290 may also, at action 3, send a bill to the payment vendor 450. In various embodiments, the bill may contain purchase amount information as well as identifying information about the signer 155, such that the bill may be paid when the signer's identity is confirmed. The payment vendor 450 may then, at action 4, send a identity confirmation request to the GSC 100 to confirm that the identified signer from the bill has signed and been confirmed as paying the bill.

At action 5, the mobile device 150 of the signer 155 may record and send electronic gesture-based signature data to the GSC 100. Next, the GSC 100 may review the received electronic gesture-based signature data and, at action 6, confirm the identity of the signer 155. At action 7, the payment vendor may then perform payment of the bill to the merchant 290 and indicate to the merchant 290 that payment has been completed. Then, at action 8, the merchant may then confirm the purchase with the signer 155.

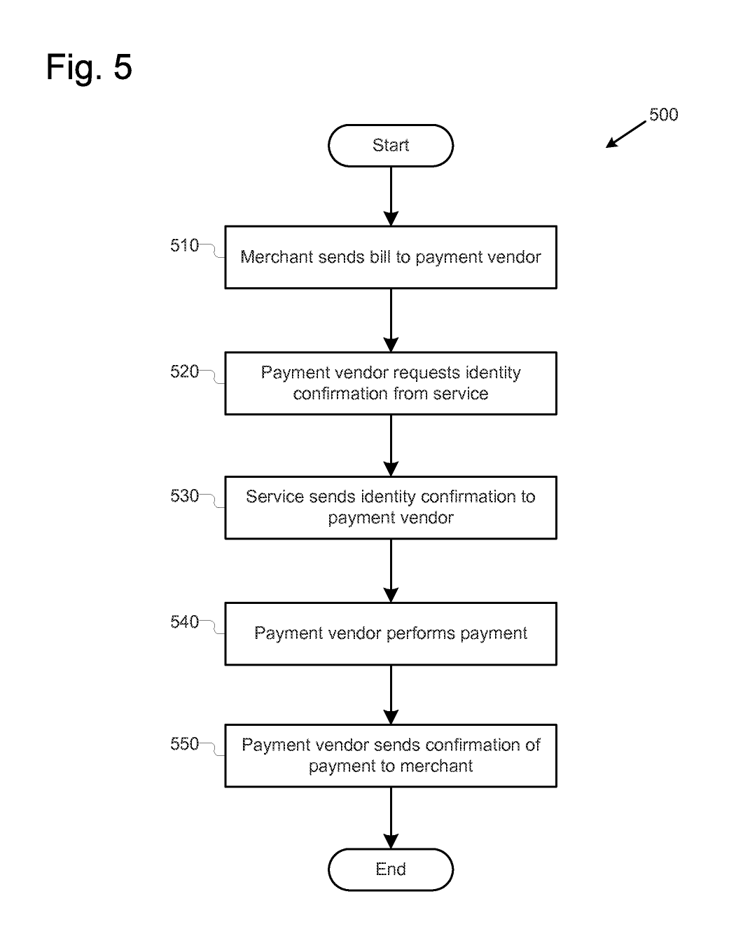

Referring now to FIG. 5, an example process for facilitating a payment using electronic gesture-based signatures is illustrated in accordance with various embodiments. While FIG. 5 illustrates particular operations in a particular order, in various embodiments, the operations may be combined, split into parts, and/or omitted. Additionally, while the illustrated embodiments, are directed to actions of the merchant 290, the payment vendor 450, and the GSC 100, in various embodiments, the signer 155 and mobile device 150 may also perform electronic gesture-based signature operations, as discussed herein.

The process may begin at operation 510, where the merchant 290 may send a bill to the payment vendor 450. In various embodiments, as discussed above, the bill may include identifying information for the signer 155, such as, for example, name information, photo information, location and/or address information, as well as a payment amount. Next, at operation 520, the payment vendor may request confirmation of the identity of the signer 155 from the GSC 100. Next, at operation 530, the GSC 100 may confirm the identity of the signer 155. In various embodiments, the GSC 100 may perform this identity confirmation with reference to electronic gesture-based signature data received from the mobile device 150 of the signer 155, as well as stored electronic gesture-based signature data, as described herein. Next, at operation 650, the payment vendor 450 may perform payment from the signer 155 to the merchant 290. In various embodiments, the payment vendor may be configured to facilitate payment between banks or other financial institutions at operation 540. Next, at operation 550, the payment vendor may send confirmation of the completed payment to the merchant 290, who may then complete the purchase transaction with the signer 155. The process may then end or repeated for another purchase.

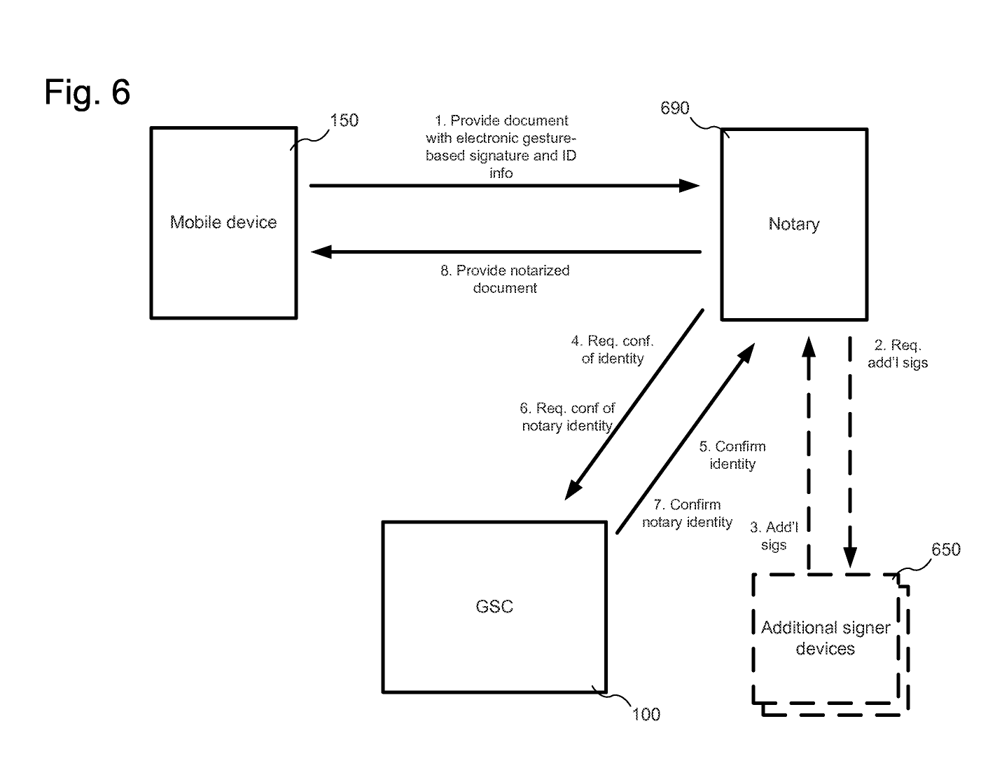

Referring now to FIG. 6, an example use case of facilitating a notarization of an electronic document is illustrated in accordance with various embodiments. In the example, the signer 155 is attempting to sign an electronic document and have the electronic document notarized by a notary 690 that is configured to work with electronic gesture-based signatures. The example may begin at action 1, where the mobile device 150 of the signer 155 may send an electronic document to the notary 690. In various embodiments, the mobile device 150 may also send recorded electronic signature data for an electronic gesture-based signature to the notary 690. Additionally, in various embodiments, the mobile device may send identifying information about the signer 155 for the notary to use in the process of notarizing the electronic document. Such identifying information may include name information, address information, location information, one or more photos of the signer 155, and/or information about the mobile device 150, such as a unique identifier (or IMEI number) for the mobile device 150.

Next, at optional action 2, the notary 690 may, if there are additional signatories to the electronic document, request signatures from additional mobile devices 650 that are associated with additional signers. Next, at optional action 3, the notary 690 may receive additional electronic signature data from the additional mobile devices 650. The notary 690 may then, at action 4, send an identity confirmation request to the GSC 100 to confirm that the identities of the identified one or more signers have been confirmed. Next, at action 5, the GSC 100 may review the received electronic gesture-based signature data and confirm the identity of the signers. Next, at action 6, the notary may optionally perform an electronic gesture-based signature themselves and send the recorded electronic signature data for said electronic gesture-based signature to the GSC 100. The GSC 100 may then confirm the identity of the notary 690 and record the notarization transaction, such as in the transaction storage 145. The GSC 100 may then, at action 7, send a confirmation to the notary 690 that the notarization was recorded. Then, at action 8, the merchant may then send the notarized electronic document to the mobile device 150 of the signer 155.

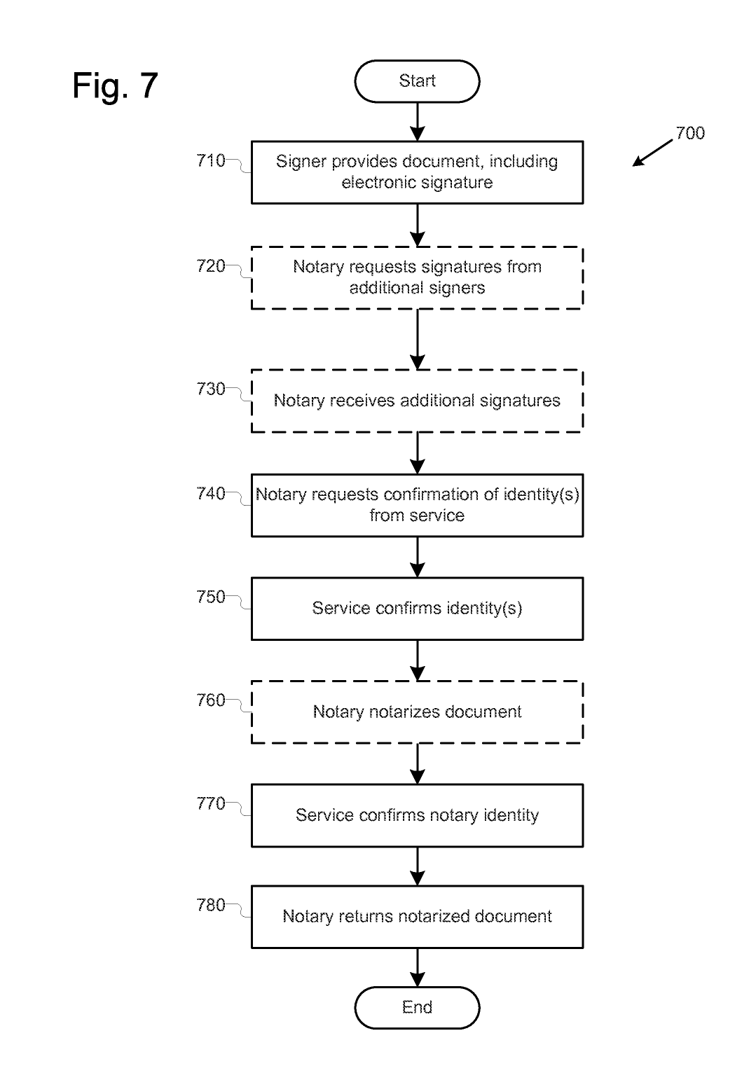

Referring now to FIG. 7, an example process for facilitating a notarization of an electronic document is illustrated in accordance with various embodiments. While FIG. 7 illustrates particular operations in a particular order, in various embodiments, the operations may be combined, split into parts, and/or omitted. The process may begin at operation 710, where the signer 155 may provide an electronic document for notarization through his or her mobile device 150 to the notary 690. In various embodiments, the signer 155 may also provide electronic signature data to sign the electronic document, as well as identifying information, as described herein. Next, at optional operation 720, if additional signers 155 are required, the notary 690 may request additional electronic signature data describing electronic gesture-based signatures from the additional signers 155. At operation 730, the electronic signature data describing these electronic gesture-based signatures may be received from the additional signers 155.

Next, at operation 740, the notary 690 may request confirmation of the identity or identities of the signers 155 from the GSC 100. Examples of confirmation of identities are described herein. Then, at operation 750, the GSC 100 may confirm the identities of the signers 155. Next, at operation 760, the notary 690 may perform their own electronic gesture-based signature to notarize the electronic document. At operation 770, the notary may optionally send a request to the GSC 100 to confirm the identity of the notary and record the notarization. At operation 780, after receiving confirmation from the GSC 100, the notary may return the notarized document. The process may then end.

In embodiments, it is contemplated that one or more parties of a multiple party document may sign the document in conventional manual and/or electronic manner. In other words, the gesture-based signature of the present disclosure may be practiced in combination with conventional signatures.

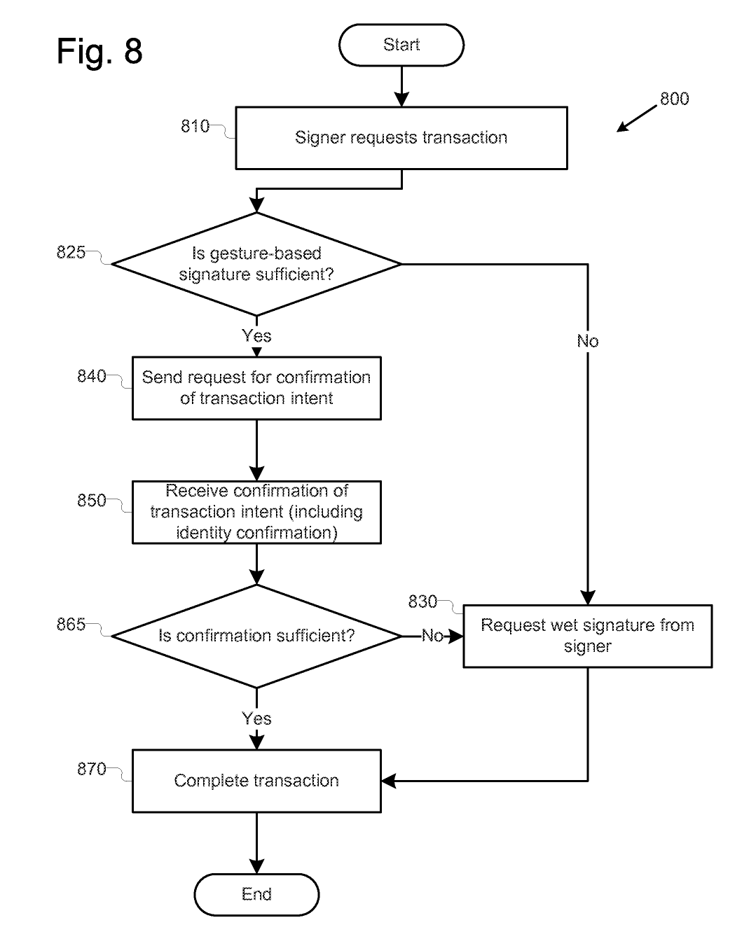

Referring now to FIG. 8, an example process 800 for facilitating performance of a transaction is illustrated in accordance with various embodiments. While FIG. 8 illustrates particular operations in a particular order, in various embodiments, the operations may be combined, split into parts, and/or omitted. In various embodiments, through performance of process 800, a party to a transaction (e.g., provider 190) may be facilitated in confirming an intent of a signer 155 to participate in the transaction. In various embodiments, the transaction may be purchase transaction of the signer 155, such as for the purchase of goods or services for a monetary amount. In other embodiments, the process may be performed to facilitate creation of a contract between two parties, such as a contract for a service to be performed. In various embodiments, through performance of process 800, the party working with the signer 155 (e.g., the provider 190) may be facilitated in accepting an electronic gesture-based signature in specific circumstances, and in requiring other types of intent indication, such as wet signatures, in other circumstances. It may be noted that, while the “provider 190” is used in the description of process 800 to refer to a party attempting to perform a transaction with the signer 155, in various embodiments, the “provider 190” may not be a provider of goods and/or services, but may instead be another party interested in participating in a transaction with the signer 155.

The process may begin at operation 810, where the signer 155 may request a transaction with a party, such as provider 190. At decision operation 825, the provider 190 may determine if an electronic gesture-based signature is sufficient for the transaction. For example, in some embodiments, the provider 190 may allow electronic gesture-based signatures only for transactions below a pre-determined money amount, such as, for example, $300. In other embodiments, the provider 190 may allow electronic gesture-based signatures only for transactions for particular types of transactions, such as allowing electronic gesture-based signatures for the purchase of goods but not for contracts for services, or vice versa. In other embodiments, other restrictions on the use of electronic gesture-based signatures may be utilized. If, at decision operation 825, the provider 190 determines that an electronic gesture-based signature is not sufficient, then at operation 830, the provider 190 may request a “wet signature” from the signer 155. In various embodiments, this “wet signature” may include a traditional pen-and-ink signature or a signature made by a finger or stylus on an electronic screen (including, in some embodiments, a screen of mobile device 150). The provider may then complete the transaction at operation 870.

If, at decision operation 825, the provider 190 determines that an electronic gesture-based signature is sufficient, then at operation 840, the provider 190 may send a request to the GSC 100 to confirm that the signer 155 intends to participate in the transaction. The GSC 100 may then request an electronic gesture-based signature from the signer 155 on the mobile device 150, according to embodiments described herein (not illustrated). Next, at operation 850, the provider 190 may receive confirmation that the signer 155 intends to participate in the transaction.

Next, at 865, the provider 190 may determine if the received confirmation is sufficient. In various embodiments, this determination may be based at least in part on information relating to the electronic gesture-based signature data received from the mobile device 150, and/or other information received regarding the mobile device 150. For example, in some embodiments, the provider 190 may receive an identification of the mobile device 150 and may only accept confirmation of intent from mobile devices 150 which have previously been identified as authorized mobile devices. In other embodiments, the provider 190 may receive an indication of a location of the mobile device 150 and may only accept confirmation of intent from mobile devices 150 which are located at an approved location, such as within a particular distance from the provider 190, or at a known place of business or residence of the signer 155. In some embodiments, the GSC 100 may itself be configured to indicate whether the electronic gesture-based signature data was sufficient for the transaction.

If, at decision operation 825, the provider 190 determines that an electronic gesture-based signature is not sufficient, then at operation 830, the provider 190 may request a wet signature from the signer 155, as described above. The provider may then complete the transaction at operation 870. The process may then end.

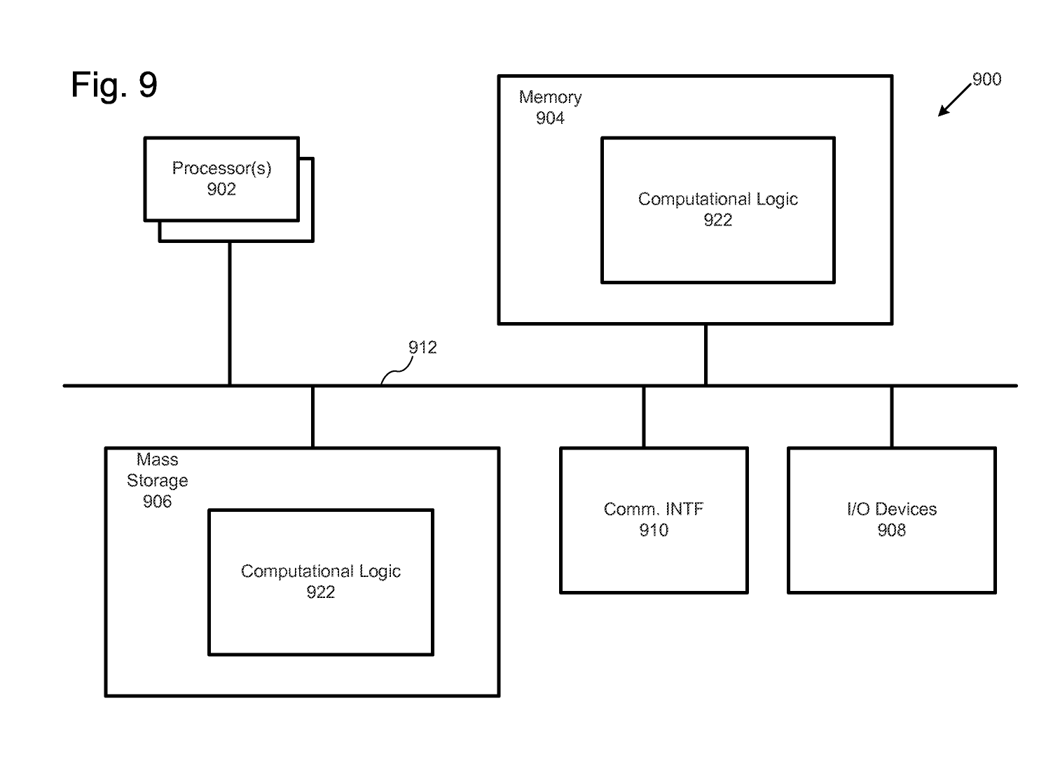

Referring now to FIG. 9, an example computer suitable for practicing various aspects of the present disclosure, including processes described herein, is illustrated in accordance with various embodiments. As shown, computer 900 may include one or more processors or processor cores 902, and system memory 904. For the purpose of this application, including the claims, the terms “processor” and “processor cores” may be considered synonymous, unless the context clearly requires otherwise. Additionally, computer 900 may include mass storage devices 906 (such as diskette, hard drive, compact disc read only memory (CD-ROM) and so forth), input/output devices 908 (such as display, keyboard, cursor control, remote control, gaming controller, image capture device, and so forth) and communication interfaces 910 (such as network interface cards, modems, infrared receivers, radio receivers (e.g., Bluetooth), and so forth). The elements may be coupled to each other via system bus 912, which may represent one or more buses. In the case of multiple buses, they may be bridged by one or more bus bridges (not shown).

Each of these elements may perform its conventional functions known in the art. In particular, system memory 904 and mass storage devices 906 may be employed to store a working copy and a permanent copy of the programming instructions implementing the modules shown in FIG. 1, and/or the operations associated with techniques shown in FIGS. 2-8, collectively referred to as computing logic 922. The various elements may be implemented by assembler instructions supported by processor(s) 902 or high-level languages, such as, for example, C, that can be compiled into such instructions.

The permanent copy of the programming instructions may be placed into permanent storage devices 906 in the factory, or in the field, through, for example, a distribution medium (not shown), such as a compact disc (CD), or through communication interface 910 (from a distribution server (not shown)). That is, one or more distribution media having an implementation of the agent program may be employed to distribute the agent and program various computing devices.

The number, capability and/or capacity of these elements 910-912 may vary. Their constitutions are otherwise known, and accordingly will not be further described.

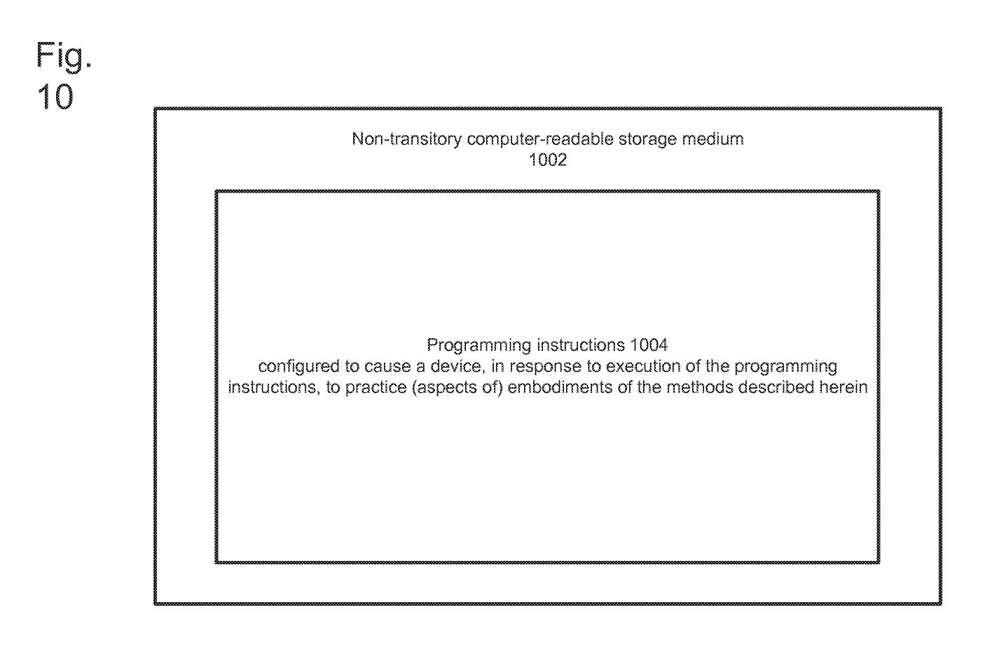

FIG. 10 illustrates an example least one computer-readable storage medium 1002 having instructions configured to practice all or selected ones of the operations associated with the techniques earlier described, in accordance with various embodiments. As illustrated, least one computer-readable storage medium 1002 may include a number of programming instructions 1004. Programming instructions 1004 may be configured to enable a device, e.g., computer 900, in response to execution of the programming instructions, to perform, e.g., various operations of processes of FIGS. 2-8, e.g., but not limited to, to the various operations performed to perform facilitation of transactions based on electronic gesture-based signatures. In alternate embodiments, programming instructions 1004 may be disposed on multiple computer-readable non-transitory storage media 1002 instead. In alternate embodiments, programming instructions 1004 may be disposed on a computer-readable transitory storage media 1002, such as signals, instead.

Various embodiments of the present disclosure have been described. These embodiments include, but are not limited to, those described in the following paragraphs.

Example 1 includes one or more non-transitory computer-readable media including instructions that are configured to cause a computing system, in response to execution of the instructions by the computing system, to facilitate identification of a first party. The instructions cause the computing system to: receive electronic signature data describing a signature formed through one or more gestures made by the first party using a mobile device; confirm an identity of the first party based at least in part on the signature gesture data; and indicate to the second party that the identity of first party has been confirmed.

Example 2 includes the computer-readable media of example 1, wherein receive electronic signature data includes receive identifying information for the first party.

Example 3 includes the computer-readable media of example 1, wherein the computing system is further caused to: receive identifying information for the first party; receive electronic signature data for the first party; and store the received identifying information and electronic signature data for subsequent confirmation of the identity of the first party.

Example 4 includes the computer-readable media of example 3, wherein confirm an identity of the first party includes comparison of the electronic signature data against stored electronic signature data associated with stored identifying information for the first party.

Example 5 includes the computer-readable media of example 1, wherein the electronic signature data includes data obtained from one or more of an accelerometer, a compass, and/or a gyroscope of the mobile device.

Example 6 includes the computer-readable media of example 1, wherein the computing system is further caused to: receive an electronic document from the first party; and subsequent to confirmation of the identity of the first party, electronically sign the electronic document to record the identity of the first party in the electronic document.

Example 7 includes the computer-readable media of example 1, wherein the computing system is further caused to facilitate a payment by the first party to the second party.

Example 8 includes the computer-readable media of example 7, wherein facilitate the payment includes: facilitate a payment from the first party to a third party; and facilitate a payment from the third party to the second party.

Example 9 includes the computer-readable media of example 1, wherein receive electronic signature data includes receive the electronic signature data from the second party.

Example 10 includes the computer-readable media of example 9, wherein the second party is a notary.

Example 11 includes the computer-readable media of example 1, wherein indicate to the second party that the identity of first party has been confirmed includes indicate to the second party that the identified first party intends to participate in a transaction.

Example 12 includes an apparatus for facilitation of identification of a first party. The apparatus includes: one or more computer processors and logic to operate on the one or more computer processors. The logic is to receive electronic signature data describing a signature formed through one or more gestures made by the first party using a mobile device; confirm an identity of the first party based at least in part on the signature gesture data; and indicate to the second party that the identity of first party has been confirmed.

Example 13 includes the apparatus of example 12, wherein receive electronic signature data includes receive identifying information for the first party.

Example 14 includes the apparatus of example 12, wherein the logic is further to: receive identifying information for the first party; receive electronic signature data for the first party; and store the received identifying information and electronic signature data for subsequent confirmation of the identity of the first party.

Example 15 includes the apparatus of example 14, wherein confirm an identity of the first party includes comparison of the electronic signature data against stored electronic signature data associated with stored identifying information for the first party.

Example 16 includes tapparatus of example 12, wherein the electronic signature data includes data obtained from one or more of an accelerometer, a compass, and/or a gyroscope of the mobile device.

Example 17 includes the apparatus of example 12, wherein the logic is further to: receive an electronic document from the first party; and subsequent to confirmation of the identity of the first party, electronically sign the electronic document to record the identity of the first party in the electronic document.

Example 18 includes the apparatus of example 12, wherein the logic is further to facilitate a payment by the first party to the second party.

Example 19 includes the apparatus of example 12, wherein receive electronic signature data includes receive the electronic signature data from the second party.

Example 20 includes the apparatus of example 12, wherein indicate to the second party that the identity of first party has been confirmed includes indicate to the second party that the identified first party intends to participate in a transaction.

Example 21 includes an computer-implemented method for facilitating identification of a first party. The method includes: receiving, by a computer system, electronic signature data describing a signature formed through one or more gestures made by the first party using a mobile device; confirming, by the computer system, an identity of the first party based at least in part on the signature gesture data; and indicating, by the computer system, to the second party that the identity of first party has been confirmed.

Example 22 includes the method of example 21, wherein receiving electronic signature data includes receiving identifying information for the first party.

Example 23 includes the method of example 21, further including: receiving, by the computer system, identifying information for the first party; receiving, by the computer system, electronic signature data for the first party; and storing, by the computer system, the received identifying information and electronic signature data for subsequent confirmation of the identity of the first party.

Example 24 includes the method of example 23, wherein confirming an identity of the first party includes comparing the electronic signature data against stored electronic signature data associated with stored identifying information for the first party.

Example 25 includes the method of example 21, wherein the electronic signature data includes data obtained from one or more of an accelerometer, a compass, and/or a gyroscope of the mobile device.

Example 26 includes the method of example 21, further including: receiving, by the computer system, an electronic document from the first party; and subsequent to confirmation of the identity of the first party, electronically signing, by the computer system, the electronic document to record the identity of the first party in the electronic document.

Example 27 includes the method of example 21, further including facilitating, by the computer system, a payment by the first party to the second party.

Example 28 includes the method of example 21, wherein receiving electronic signature data includes receiving the electronic signature data from the second party.

Example 29 includes the method of example 21, wherein indicating to the second party that the identity of first party has been confirmed includes indicating to the second party that the identified first party intends to participate in a transaction.

Example 30 includes one or more computer-readable media including instructions that are configured to cause a computing system, in response to execution of the instruction by the computing system, to facilitate notarization of electronic documents. The instructions cause the computing system to: receive an electronic document from a party; receive electronic signature data describing a signature of the party formed through one or more gestures made by the party using a mobile device; send the electronic signature data to a signature confirmation service on another computing system to confirm an identity of the party; receive, from the signature confirmation service, confirmation of the identity of the party; and upon receipt of confirmation of the identity of the party, notarize the electronic document.

Example 31 includes the computer-readable media of example 30, wherein notarize the electronic document includes: receive electronic notary signature data describing a signature formed through one or more gestures made by a notary party using a mobile device; send the electronic notary signature data to a notary signature confirmation service to confirm an identity of the notary party; receive, from the notary signature confirmation service, confirmation of the identity of the notary party; and upon receipt of confirmation of the identity of the notary party, notarize, by the computing system, the electronic document.

Example 32 includes the computer-readable media of example 30, wherein the electronic document is configured to include signatures of multiple parties. The computing system is also further caused to: for each additional party, solicit an additional electronic signature data describing an additional signature formed with one or more gestures from an additional party; and send the additional electronic signature data to a signature confirmation service to confirm the identity of the additional party. Also, notarize the electronic document includes notarize the electronic document after receipt of confirmation of the identities of the multiples parties.

Example 33 includes the computer-readable media of example 30, wherein the computing system is further caused to receive identifying information for the party.

Example 34 includes the computer-readable media of example 33, wherein the identifying information includes a photo of the party, and wherein the computing system is further caused to match the photo of the party against photos in a photo database.

Example 35 includes the computer-readable media of example 33, wherein the identifying information includes location information for the mobile device, and wherein t the computing system is further caused to record the location information in the electronic document.

Example 36 includes the computer-readable media of example 33, wherein the identifying information includes unique identifying information for the mobile device, and wherein t the computing system is further caused to verify the unique identifying information for the mobile device.

Example 37 includes a method for facilitating notarization of electronic documents, the method including: receiving, by a computing system, an electronic document from a party; receiving, by the computing system, electronic signature data describing a signature of the party formed through one or more gestures made by the party using a mobile device; sending, by the computing system, the electronic signature data to a signature confirmation service on another computing system to confirm an identity of the party; receiving, by the computing system, from the signature confirmation service, confirmation of the identity of the party; and upon receipt of confirmation of the identity of the party, notarizing, by the computing system, the electronic document.

Example 38 includes the method of example 37, wherein notarizing the electronic document includes: receiving electronic notary signature data describing a signature formed through one or more gestures made by a notary party using a mobile device; sending the electronic notary signature data to a notary signature confirmation service to confirm an identity of the notary party; receiving, from the notary signature confirmation service, confirmation of the identity of the notary party; and upon receipt of confirmation of the identity of the notary party, notarizing, by the computing system, the electronic document.

Example 39 includes the method of example 37, further including receiving, by the computing system, identifying information for the party.

Example 40 includes one or more computer-readable media including instructions that are configured to cause a computing system, in response to execution of the instructions by the computing system, to facilitate purchase transactions. The instructions cause the computing system to: receive an indication of a purchase transaction made between a provider party and a paying party, the indication including a purchase amount; receive, from a signature confirmation service on a separate computing system, an indication that an identity of the second party has been confirmed; facilitate payment of the purchase amount from the paying party to the providing party; and send an indication to the providing party that the payment was made.

Example 41 includes the computer-readable media of example 40, wherein the computing system is further caused to, in response to receipt of the indication of the purchase transaction, request confirmation of the identity of the paying party.

Example 42 includes the computer-readable media of example 40, wherein the computing system is further caused to, prior to send the indication to the providing party that the payment was made, confirm with a financial institution that the paying party has sufficient funds and/or credit to make payment to the providing party.

Example 43 includes the computer-readable media of example 40 wherein receive an indication of a purchase transaction made between a provider party and a paying party includes receive identifying information for one or more of the provider party and the paying party.

Example 44 includes the computer-readable media of example 43, wherein identifying information for the paying party includes a unique identifier for a mobile device under control of the paying party.

Example 45 includes the computer-readable media of example 44 wherein receive an indication that an identity of the second party has been confirmed includes receive an indication that the paying party formed a signature through one or more gestures made by the paying party using the mobile device.

Example 46 includes a computer-implemented method for facilitating purchase transactions, the method including: receiving, by a computing system, an indication of a purchase transaction made between a provider party and a paying party, the indication including a purchase amount; receiving, by the computing system, from a signature confirmation service on a separate computing system, an indication that an identity of the second party has been confirmed; facilitating, by the computing system, payment of the purchase amount from the paying party to the providing party; and sending, by the computing system, an indication to the providing party that the payment was made.

Example 47 includes the method of example 46, further including, in response to receipt of the indication of the purchase transaction, requesting, by the computing system, confirmation of the identity of the paying party.

Example 48 includes the method of example 46, further including, prior to sending the indication to the providing party that the payment was made, confirming with a financial institution that the paying party has sufficient funds and/or credit to make payment to the providing party.

Example 49 includes the method of example 46 wherein receiving an indication of a purchase transaction made between a provider party and a paying party includes receiving identifying information for one or more of the provider party and the paying party.

Example 50 includes the method of example 49, wherein identifying information for the paying party includes a unique identifier for a mobile device under control of the paying party.

Example 51 includes the method of example 49 wherein receiving an indication that an identity of the second party has been confirmed includes receiving an indication that the paying party formed a signature through one or more gestures made by the paying party using the mobile device.

Example 52 includes one or more computer-readable media including instructions that are configured to cause a mobile computing device, in response to execution of the instructions by the mobile computing device, to facilitate confirmation of identity of a party by causing the mobile computing device to: record electronic signature data describing one or more physical gestures made by the party using the mobile computing device; and send an electronic signature notification to a signature confirmation service, the electronic signature notification including the electronic signature data and identifying information for the party.

Example 53 includes the computer-readable media of example 52, wherein record electronic signature data includes record one or more physical movements of the mobile computing device by the party.

Example 54 includes the computer-readable media of example 53, wherein record one or more physical movements includes record data measured from one or more of: an accelerometer, a compass, or a gyroscope.

Example 55 includes the computer-readable media of example 52, wherein identifying information for the party includes name information for the party.

Example 56 includes the computer-readable media of example 52, wherein identifying information for the party includes password information for the party.

Example 57 includes the computer-readable media of example 52, wherein identifying information for the party includes a unique identifier for the mobile computing device.

Example 58 includes the computer-readable media of example 57, wherein the unique identifier for the mobile computing device includes an International Mobile Station Equipment Identity number for the mobile computing device.

Example 59 includes a computer-implemented method for facilitating confirmation of identity of a party, the method including: recording, by a computing system, electronic signature data describing one or more physical gestures made by the party using the mobile computing device; and sending, by the computing system, an electronic signature notification to a signature confirmation service, the electronic signature notification including the electronic signature data and identifying information for the party.

Example 60 includes the method of example 59, wherein recording electronic signature data includes recording one or more physical movements of the mobile computing device by the party.

Example 61 includes the method of example 60, wherein recording one or more physical movements includes recording data measured from one or more of: an accelerometer, a compass, or a gyroscope.

Example 62 includes the method of example 59, wherein identifying information for the party includes one or more of: name information for the party, password information for the party, or a unique identifier for the mobile computing device.

Example 63 includes the method of example 62, wherein the unique identifier for the mobile computing device includes an International Mobile Station Equipment Identity number for the mobile computing device.

Example 64 includes one or more computer-readable media including instructions that are configured to cause a mobile computing device, in response to execution of the instructions by the mobile computing device, to facilitate performance of a transaction by causing the mobile computing device to: receive a request for a transaction by a party; transmit a request to receive confirmation of the party's intent to participate in the transaction; and receive a confirmation of the first party's intent to participate in the transaction, the confirmation being based on electronic gesture-based signature data describing one or more physical gestures made by the party using a mobile computing device.

Example 65 includes the computer-readable media of example 64, wherein the mobile computing device is further caused to determine whether an electronic gesture-based signature is sufficient to confirm the party's intent to participate in the transaction.

Example 66 includes the computer-readable media of example 65, wherein determine whether an electronic gesture-based signature is sufficient includes determine whether the transaction involves monetary amounts within pre-determined limits.

Example 67 includes the computer-readable media of example 65, wherein determine whether an electronic gesture-based signature is sufficient includes determine whether the mobile computing device is an authorized mobile computing device.

Example 68 includes the computer-readable media of example 65, wherein determine whether an electronic gesture-based signature is sufficient includes determine if the one or more physical gestures made by the party at an accepted physical location.

Example 69 includes a computer-implemented method for facilitating performance of a transaction, the method including: receiving, by a computing system, a request for a transaction by a party; transmitting, by the computing system, a request to receive confirmation of the party's intent to participate in the transaction; and receiving, by the computing system, a confirmation of the first party's intent to participate in the transaction, the confirmation being based on electronic gesture-based signature data describing one or more physical gestures made by the party using a mobile computing device.

Example 70 includes the method of example 69, wherein further including determining, by the computing system, whether an electronic gesture-based signature is sufficient to confirm the party's intent to participate in the transaction.

Example 71 includes the method of example 70, wherein determining whether an electronic gesture-based signature is sufficient includes determining whether the transaction involves monetary amounts within pre-determined limits.

Example 72 includes the method of example 70, wherein determining whether an electronic gesture-based signature is sufficient includes determining whether the mobile computing device is an authorized mobile computing device.

Example 73 includes the method of example 70, wherein determining whether an electronic gesture-based signature is sufficient includes determining if the one or more physical gestures made by the party at an accepted physical location.

Computer-readable media (including at least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more non-transitory computer-readable media comprising instructions that are configured to cause a computing system, in response to execution of the instructions by the computing system, to facilitate identification of a first party by causing the computing system to:
receive electronic signature data describing a signature formed through one or more gestures made by the first party using a mobile device;
confirm an identity of the first party based at least in part on the signature gesture data; and
indicate to the second party that the identity of first party has been confirmed.

2. The computer-readable media of claim 1, wherein receive electronic signature data comprises receive identifying information for the first party.

3. The computer-readable media of claim 1, wherein the computing system is further caused to:
receive identifying information for the first party;
receive electronic signature data for the first party; and
store the received identifying information and electronic signature data for subsequent confirmation of the identity of the first party.

4. The computer-readable media of claim 3, wherein confirm an identity of the first party comprises comparison of the electronic signature data against stored electronic signature data associated with stored identifying information for the first party.

5. The computer-readable media of claim 1, wherein the electronic signature data comprises data obtained from one or more of an accelerometer, a compass, and/or a gyroscope of the mobile device.

6. The computer-readable media of claim 1, wherein the computing system is further caused to:
receive an electronic document from the first party; and
subsequent to confirmation of the identity of the first party, electronically sign the electronic document to record the identity of the first party in the electronic document.

7. The computer-readable media of claim 1, wherein the computing system is further caused to facilitate a payment by the first party to the second party.

8. The computer-readable media of claim 7, wherein facilitate the payment comprises:
facilitate a payment from the first party to a third party; and
facilitate a payment from the third party to the second party.

9. The computer-readable media of claim 1, wherein receive electronic signature data comprises receive the electronic signature data from the second party.

10. The computer-readable media of claim 9, wherein the second party is a notary.

11. The computer-readable media of claim 1, wherein indicate to the second party that the identity of first party has been confirmed comprises indicate to the second party that the identified first party intends to participate in a transaction.

12. An apparatus for facilitation of identification of a first party, the apparatus comprising:
one or more computer processors; and
logic to operate on the one or more computer processors to:
receive electronic signature data describing a signature formed through one or more gestures made by the first party using a mobile device;
confirm an identity of the first party based at least in part on the signature gesture data; and
indicate to the second party that the identity of first party has been confirmed.

13. The apparatus of claim 12, wherein receive electronic signature data comprises receive identifying information for the first party.

14. The apparatus of claim 12, wherein the logic is further to:
receive identifying information for the first party;
receive electronic signature data for the first party; and
store the received identifying information and electronic signature data for subsequent confirmation of the identity of the first party.

15. The apparatus of claim 14, wherein confirm an identity of the first party comprises comparison of the electronic signature data against stored electronic signature data associated with stored identifying information for the first party.

16. The apparatus of claim 12, wherein the electronic signature data comprises data obtained from one or more of an accelerometer, a compass, and/or a gyroscope of the mobile device.

17. The apparatus of claim 12, wherein the logic is further to:
receive an electronic document from the first party; and
subsequent to confirmation of the identity of the first party, electronically sign the electronic document to record the identity of the first party in the electronic document.

18. The apparatus of claim 12, wherein the logic is further to facilitate a payment by the first party to the second party.

19. The apparatus of claim 12, wherein receive electronic signature data comprises receive the electronic signature data from the second party.

20. The apparatus of claim 12, wherein indicate to the second party that the identity of first party has been confirmed comprises indicate to the second party that the identified first party intends to participate in a transaction.

21. An computer-implemented method for facilitating identification of a first party, the method comprising:
receiving, by a computer system, electronic signature data describing a signature formed through one or more gestures made by the first party using a mobile device;
confirming, by the computer system, an identity of the first party based at least in part on the signature gesture data; and
indicating, by the computer system, to the second party that the identity of first party has been confirmed.

22. The method of claim 21, wherein receiving electronic signature data comprises receiving identifying information for the first party.

23. The method of claim 21, further comprising:
receiving, by the computer system, identifying information for the first party;
receiving, by the computer system, electronic signature data for the first party; and
storing, by the computer system, the received identifying information and electronic signature data for subsequent confirmation of the identity of the first party.

24. The method of claim 23, wherein confirming an identity of the first party comprises comparing the electronic signature data against stored electronic signature data associated with stored identifying information for the first party.

25. The method of claim 21, wherein the electronic signature data comprises data obtained from one or more of an accelerometer, a compass, and/or a gyroscope of the mobile device.

26. The method of claim 21, further comprising:
receiving, by the computer system, an electronic document from the first party; and
subsequent to confirmation of the identity of the first party, electronically signing, by the computer system, the electronic document to record the identity of the first party in the electronic document.

27. The method of claim 21, further comprising facilitating, by the computer system, a payment by the first party to the second party.

28. The method of claim 21, wherein receiving electronic signature data comprises receiving the electronic signature data from the second party.

29. The method of claim 21, wherein indicating to the second party that the identity of first party has been confirmed comprises indicating to the second party that the identified first party intends to participate in a transaction.
